(19) United States
(12) Patent Application Publication
(10) Pub. No.: US 2004/0081119 A1
(43) Pub. Date: Apr. 29, 2004

(54) Reducing packet drop in IEEE 802.11 handoff by packet forwarding using driver image queue

(76) Inventors: Zhun Zhong, Croton on Hudson, NY (US); Marc Portoles, Sant Cugat (ES); Sunghyun Choi, Seoul (KR)

Correspondence Address: PHILIPS INTELLECTUAL PROPERTY & STANDARDS, P.O. BOX 3001, BRIARCLIFF MANOR, NY, 10510, US

(21) Appl. No.: 10/281,847

(22) Filed: Oct. 28, 2002

(51) Int. Cl. H04Q 7/00; H04Q 7/24

(52) U.S. Cl. 370/328; 370/331; 370/338; 370/359

(57) ABSTRACT

The present invention is a method and system for reducing and potentially eliminating the number of packets dropped during 802.11 handoff by an old access point (AP) to a new AP in a wireless local area network (WLAN) which thereby also reduces the impact of retransmission on network throughput. With the present invention, once a mobile station has successfully re-associated with a new AP, the new AP can fetch those packets which arrived at the old AP during handoff and forward them to the mobile station. The method and system of the present invention thus reduces both total packet drop and retransmission impact on network throughput by enabling direct recovery of packets received during handoff by the old AP from the old AP.

### BACKGROUND OF THE INVENTION

1. Field of the Invention

The present invention relates to communications systems. More particularly, the present invention relates to a system and method for reducing data packet loss during handoff in an IEEE 802.11 wireless local area network (WLAN). Most particularly, the present invention relates to reducing data packet loss during handoff in a WLAN by one of modifying card firmware to send the contents of the card's queue back to a higher layer upon request, or mirroring the queue in the card in the WLAN interface driver so that an old Access Point (AP) can forward unsent data packets to a new AP during handoff.

2. Description of the Related Art

In a typical wireless communication system, such as IEEE 802.11 WLAN, the mobile station connect to the network via the Access Point (AP). Each AP covers a certain area and serves the mobile stations within that area. Before any data communication occur between a mobile station and an AP, the mobile station need to first associate with the AP. When the link between the mobile station and the AP becomes bad, it may become necessary for the mobile station to re-associate with a new AP with a better link quality to handle the two-way communication. The bad link may occur due to the distance moved or because of some other interference with communication. The process by which the mobile station terminates the communication with the old AP and re-associates with a new AP is termed “handoff”.

Handoff requires a finite amount of time for the mobile station and a new AP to accomplish the operations necessary for locating and authenticating the new AP before the new AP can begin serving the mobile station. Meanwhile, before handoff is completed, packets addressed to the mobile station may keep arriving at the old AP which can no longer reach the mobile station, since the mobile station has terminated communication with the old AP. During this handoff period there is no way for the old AP to forward any packets that have arrived at the old AP to the mobile station. For User Datagram Protocol (UDP), the packets arriving at the old AP during handoff are dropped and the mobile station experiences data loss. For Transmission Control Protocol (TCP), these packets are retransmitted by the sender after the handoff but the retransmission has an impact on network throughput.

One approach to reducing packet loss captures packets arriving at the old AP in a buffer during handoff. Then, once the mobile station re-associates with a new AP, the new AP fetches the buffered packets from the old AP and forwards them to the mobile station. In one present state of the art system, as illustrated in FIG. 1, a buffer 13 is located between the network layer 10 and the wireless interface driver 11 to hold the packets which arrive at the old AP during handoff. The state-of-the-art system of FIG. 1 helps reduce the number of dropped packets during handoff by buffering packets that cannot be accepted by the wireless interface driver 11. The underlying assumption on which this approach is founded is that every packet accepted by the wireless interface driver 11 is delivered to the mobile station. This assumption is valid only if the network interface card 12 immediately delivers to the mobile station any packet forwarded to it by the wireless interface driver 11. The fact remains, however, that almost all network interface cards 12 have built-in queues capable of holding several packets. And therefore, given this queuing of packets by a wireless interface card 12, there is no guarantee that the delivery of a packet to the wireless interface card 12 by the wireless interface driver 11 necessarily results in the delivery of the packet by the wireless interface card 12 over the wireless medium to the mobile station.

Further, since the buffer 13 in the prior art system of FIG. 1 is placed before the wireless interface driver 11, it only holds packets that have not been sent to the wireless interface driver 11. The state-of-the-art system of FIG. 1 does not have any way to recover those packets already sent by the wireless interface driver 11 to the wireless interface card 12 that could not be delivered by the wireless interface card 12 to the mobile station during handoff. FIG. 2 illustrates a wireless interface card 12 having a queue 14 containing packets that could not be delivered by the wireless interface card 12 during handoff and which cannot be recovered for subsequent delivery to the mobile station.

### SUMMARY OF THE INVENTION

Therefore, there is a need for a scheme than can reduce, if not eliminate, the data loss during handoff and the impact of retransmission on network throughput. The present invention is a novel method and system for reducing data packet loss during handoff in a wireless communication system and any impact of retransmission of network throughput. The method and system of the present invention accomplishes this by recovering the packets already in the wireless interface card queue that have not yet been delivered to the mobile station.

In one preferred embodiment of the present invention, the card firmware is modified so that the packets held in the card queue can be fetched by a higher protocol layer in the old AP for forwarding to the new AP.

In an alternative preferred embodiment of the present invention, the card queue is mirrored in an image queue by the wireless interface driver and the wireless interface card reports delivery of each packet to the wireless interface driver so that the driver can delete the packet from its image queue.

### BRIEF DESCRIPTION OF THE DRAWINGS

FIG. 1 illustrates prior art buffering of packets above the wireless interface driver during handoff.

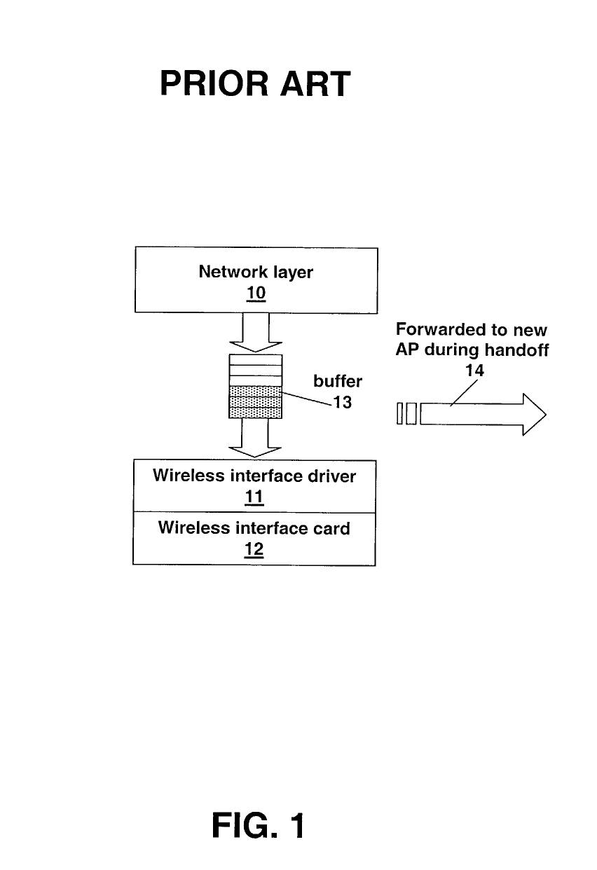

FIG. 2 illustrates prior art queuing of packets by a wireless interface card.

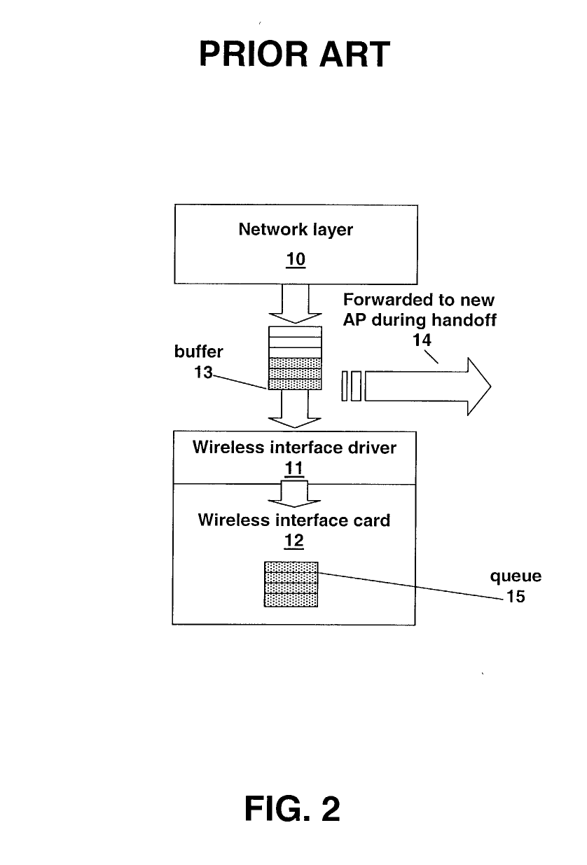

FIG. 3 illustrates a mirror image queue maintained by the wireless interface driver of the wireless interface card queue.

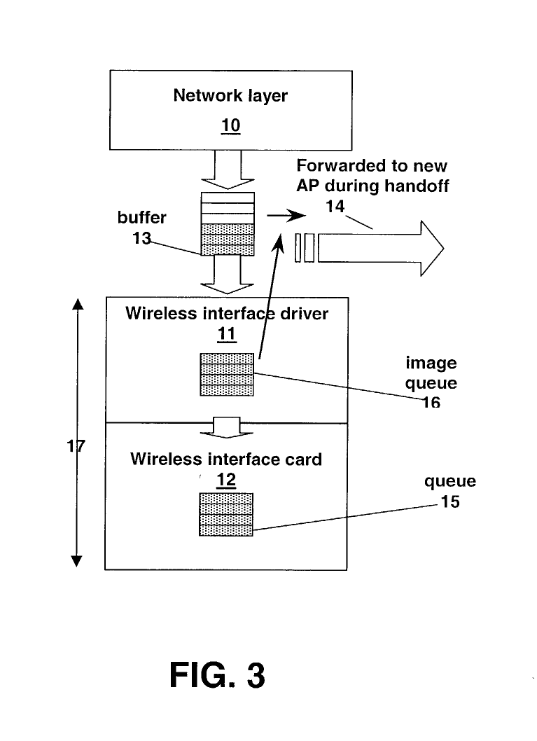

### DETAILED DESCRIPTION OF THE INVENTION

The present invention is a method and system for reducing and potentially eliminating the number of packets dropped during handoff by an old AP to a new AP in a WLAN and thereby reducing the impact of retransmission on network throughput. With the present invention, once a mobile station has successfully re-associated with a new AP, the new AP can fetch those packets which arrived at the old AP during handoff, are currently in the wireless interface card queue, and forward them to the mobile station. The method and system of the present invention thus reduces both total packet drop and retransmission impact on network throughput by enabling direct recovery of packets received during handoff from the old AP.

In a preferred embodiment, a change is made to the firmware of the wireless interface card 12 so that packets held in the card's queue of packets 14 can be sent back to a higher protocol layer upon request. In this embodiment, a higher protocol layer in the old AP is able to fetch packets in the wireless interface card queue 15 and forward them to the new AP 14 during handoff. Note that this embodiment requires changing the firmware in the wireless interface card, which must be done by the card vendor.

An alternative preferred embodiment does not rely on changing the firmware of the wireless interface card. In this alternative embodiment, a mirror image queue 16 is added to the wireless interface driver 11 to mirror the queue 15 in the wireless interface card 12. In this alternative, for every packet sent to the wireless interface card 12 by the wireless interface driver 11, the driver 11 keeps a copy in a mirror image queue 16. Whenever a packet is received by the mobile station from the wireless interface card 12, the card 12 reports, i.e., acknowledges delivery, to the driver 11 and the driver deletes the packet from its mirror image queue 16. That is, the mirror image queue contains packets which have not been acknowledged as delivered by the mobile station either because they have not yet been sent to the station or because the station has not reported their receipt, i.e., acknowledged their delivery. By this means, the wireless interface driver 11 is able to independently maintain the status of the queue 15 in the wireless interface card 12 by retaining copies of the packets sent to the wireless interface card and not reported as delivered in a mirror image queue 16, i.e., a mirror image queue 16 of packets currently in the wireless interface card queue 15 awaiting delivery to the mobile station. Once the new AP asks for buffered packets, the old AP will forward not only those packets held in the buffer 13 above the wireless interface driver 11, but also the packets held in the wireless interface driver image queue 16, as none of these latter packets have been delivered to the mobile station.

However, in this alternative embodiment, care must be taken to avoid possible duplicate packets being delivered to the mobile station. Duplication may occur for the first packet in the wireless interface driver queue 16. During handoff it is likely that the wireless interface card has delivered the first packet in its queue 15 to the mobile station but has not received and acknowledgement (ACK) from the station because the station moves out of range or from some other environmental factor. In this case, the wireless interface card 12 does not signal the driver 11 that a delivery of the first packet has taken place. As a result, the wireless interface driver 11 keeps the first packet at the head of the image queue 16. After the mobile station re-associates with the new AP, the packet is forwarded to the new AP, which forwards it to the mobile station. As the station has received the packet before the handoff from the old AP, there is duplicate delivery of the packet. Therefore, to avoid such duplication, in this alternative preferred embodiment the first packet is discarded from the image queue 16 of the wireless interface driver 11 when forwarding packets to the new AP.

It should be noted that modifications and variations to the preferred embodiments presented above can be made by persons skilled in the art without departing from the scope and spirit of the present invention. The foregoing description of the preferred embodiments of the present invention have been presented as illustrative and not in any limiting sense and the scope of the present invention is to be limited solely by the scope and spirit of the following claims.

We claim:

1. A method of reducing packet drop during IEEE 802.11 handoff of a mobile station from a first to a second access point (AP) of a plurality of APs connected to each other in a wireless local area network (WLAN), each of said plurality of APs comprising a layered data transport architecture having a lowest physical layer and a least one higher protocol layer that includes a network layer for receiving a packet from the network and forwarding said packet to said lowest physical layer of said data transport architecture, said lowest layer comprising a wireless interface driver connected to a wireless interface card, for delivery of said packets to the mobile station, said method comprising the steps of:
a) recovering a packet held in a queue of undelivered packets in the first AP;
b) forwarding the recovered packet to the second AP; and
c) repeating steps a) and b) for each packet stored in the queue of undelivered packets of the first AP.

2. The method of claim 1, wherein:
said queue is in the wireless interface card of the first AP;
said recovering step a) further comprises providing said packet to said at least one higher protocol layer in the first AP by a firmware in the wireless interface card of said first AP; and
said forwarding step b) further comprises forwarding the provided packet to the second AP by said at least one higher protocol layer of said first AP.

3. The method of claim 1, further comprising the steps of:
d) mirroring the queue of undelivered packets in the wireless interface card in a mirror image queue of undelivered packets in the wireless interface driver;
e) reporting to the wireless interface driver the delivery of a packet to the mobile station; f) deleting the reported packet from the mirror image queue of undelivered packets in the wireless interface driver; and
wherein:
in steps a) and c) the queue is the mirror image queue of undelivered packets of said first AP.

4. The method of claim 3, wherein the step of recovering a packet held in the mirror image queue further comprises the step of ignoring a first packet in said mirror image queue such that duplicate delivery of said first packet is avoided.

5. A computerized system comprising:
a plurality of access points (APs) connected to each other in a wireless local area network (WLAN), each of said plurality of APs having a standard layered data transport mechanism including a wireless interface for delivery of a packet received from said WLAN to a mobile station, at least one higher layer for handoff of the mobile station from a first to a second AP;
at least one queue within said wireless interface of said standard mechanism in which each packet received by the wireless interface is stored until delivery of the packet is acknowledged by the mobile station and is then deleted; and
a packet management mechanism within said wireless interface by which a packet in said at least one queue is provided to said at least one higher layer,
wherein, during handoff of the mobile station from the first to the second AP, when the second AP requests packets not yet delivered by the first AP, the packet management mechanism of said first AP provides each packet stored in the at least one queue of the wireless interface to the higher protocol layer and said higher layer forwards each said provided packet to the second AP such that packet drop during handoff is reduced.

6. The computerized system of claim 5, wherein said wireless interface comprises a wireless interface driver for receiving a packet from the network and for forwarding said packet to a connected wireless interface card, said wireless interface card using one of said at least one queue for storing said forwarded packet until delivery of said stored packet by the wireless interface card to the mobile station is acknowledged by the mobile station and then deleting the acknowledged packet from said at least one queue.

7. The computerized system of claim 6, wherein said packet management mechanism comprises firmware in said wireless interface card that provides the packets in said one of said at least one queue used by said wireless interface card to the higher layer during handoff.

8. The computerized system of claim 7 wherein:
said at least one queue is a mirrored queue comprising an original queue and a duplicate of said original queue, said original queue being used as said one of said at least one queue by said wireless interface card;
said packet management mechanism further comprises a first and second component in said wireless interface driver and said wireless interface card, respectively, said second component reporting to said first component of delivery of a packet to the mobile station so that said first component deletes the reported packet from said duplicate queue resulting, and said first component providing each packet stored in the duplicate queue to the higher protocol layer for delivery to the second AP.

9. The computerized system of claim 8, wherein:
a packet stored in each said original and duplicate queue is entered in said queue in order of receipt of said packet, ending with a most recently received packet being stored last; and
said first packet in said duplicate queue is not provided to said higher protocol layer for forwarding to said second AP during handoff in order to avoid duplicate delivery of said first packet.
